(19) United States
(12) Patent Application Publication
(10) Pub. No.: US 2008/0041969 A1
(43) Pub. Date: Feb. 21, 2008

(54) Remote control vent system

(76) Inventor: Nathan Nathan, Searingtown, NY (US)

Correspondence Address: MAYER BROWN LLP, P.O. BOX 2828, CHICAGO, IL, 60690, US

(21) Appl. No.: 11/506,274

(22) Filed: Aug. 18, 2006

(51) Int. Cl. F24F 7/00; G05D 23/00

(52) U.S. Cl. 236/49.3; 236/51

(57) ABSTRACT

A remote control vent system having a vent unit and a remote control unit is disclosed. In one embodiment the vent unit has a frame having an opening, a plurality of louvers pivotally connected to the frame, a drive unit engaging the louvers and a remote control sensor in communication with the drive unit. The remote control unit communicates with the remote control sensor.

### FIELD OF THE INVENTION

The present invention relates generally to the field of heating and air-conditioning, and more specifically to vent units and control systems for heating-ventilation and air conditioning (HVAC) units.

### BACKGROUND OF THE INVENTION

A majority of homes and businesses in the United States employ some form of HVAC unit (or units) to heat and cool the various rooms of a building. Such systems commonly use a forced-air system to move heated or cooled air through ducts installed in the building. The ducts terminate in the rooms of the building, allowing the HVAC system to direct hot or cold air throughout the building effectively heating or cooling the entire space.

The terminus of the ducts is not typically left wide open or without obstruction, but rather a vent or register unit is commonly installed at each said duct terminus. The standard vent or register typically has two sets of louvers. One set of louvers is interior to the register frame and may be manually opened or shut typically by use of a lever or wheel mechanically linked to the louvers. The lever is accessible to an operator exterior to the register. The other set of louvers is incorporated into the frame of the register at its exterior face and is not movable; such louvers usually are angled such that half of the louvers direct air in one direction and the other half direct the air in another direction.

These prior art vents or registers have several disadvantages. First, there is limited control over the direction of air exiting the vent, as the external louvers that direct the air exiting the duct are fixed, with the only controllable louvers positioned behind the fixed louvers. Also, registers are typically close to the floor, close to the ceiling, or in the floor or ceiling. Manually opening or closing registers near or in the ceiling requires a person to step up onto something to reach the lever, thus requiring a person to find something on which to stand and subjecting the person to a risk of falling. Manually opening or closing registers near or in the floor, while easier than those at ceiling level, may still cause discomfort by requiring a person to bend over or kneel on the floor to open or close the register with accuracy. This is of particular concern for those who are physically challenged in some way or have limited mobility, balance or strength.

Most current HVAC systems incorporate the use of a thermostat. The thermostat contains some type of temperature sensor, and the thermostat is typically mounted on a wall somewhere in the house. A building occupant may set the thermostat to a desired temperature, and the thermostat will communicate with an HVAC unit in some manner to trigger heating or cooling until the temperature at the location of the thermostat has reached the desired temperature. Such central control of an HVAC system is well known in the art.

Typically, a thermostat's positioning in a building is chosen at the time of construction. As such, the thermostat's position is rendered static as moving the thermostat would be inconvenient and the expense may be substantial. Thus, if an occupant is in a room far from the thermostat but is uncomfortable, he or she must adjust the thermostat to a different temperature by leaving the room and going to the location of the thermostat. This action, of course, changes the temperature in the remainder of the rooms of the building or zone and can make others uncomfortable. Furthermore, within a single room there can be a temperature gradient with some areas of the room being warmer than others. Even in a room where the thermostat is located, the thermostat will be on a given wall while the primary location within the room where occupants are likely to be located is somewhere toward the center of the room, for example on a couch or at a desk.

It therefore would be advantageous to provide a vent and remote control system that could be installed at the terminus of a duct of an HVAC system that is already installed in a building, without any need for a change in wiring. It would further be desirable if the vent could be adjusted without resorting to a manual lever. It also would be desirable to control the direction of the air from the vent. It further would be desirable to have a remote control that an operator could place at any location in a respective room so as to control temperature at a desired location in a room and be able to relocate the remote control with the movement of the occupants in the room, rather than being limited to one location in a building or only along a wall in the room.

### SUMMARY OF THE INVENTION

These and other needs are met by the invention now disclosed. In one aspect of the invention, a remote control vent system having a vent unit and a remote control unit is disclosed. In one embodiment the vent unit has a frame having an opening, a plurality of louvers pivotally connected to the frame, a drive unit engaging the louvers and a remote control sensor in communication with the drive unit. The remote control unit communicates with the remote control sensor.

In another aspect of the invention, a remote control vent system has a vent unit with a frame having an opening, a plurality of louvers pivotally connected to the frame, a drive unit, a driven portion connected to each respective louver, a remote control sensor in communication with the drive unit, and a movable member connected to the drive unit and engaging the driven portions. The system has a remote control unit having at least one input device engageable by an operator, a temperature sensor, and a display screen, wherein the remote control unit is programmable by the operator for a temperature specification at a location of the remote control unit or is programmable for a temperature specification at a location of the remote control unit at a specified time.

In another aspect of the invention, a method for controlling the temperature 6f a selected location in a room is disclosed. The method includes the steps of installing a vent unit having a drive unit and remote control sensor in the room, wherein the vent unit conveys air from a heating or cooling source, providing a remote control that communicates with the drive unit via the remote control sensor, the remote control being programmable by an operator to a selected temperature and having a temperature sensing device, programming the remote control to a temperature specification, and placing the remote control at the selected location.

### BRIEF DESCRIPTION OF THE DRAWINGS

FIG. 1 is a front view of one embodiment of the invention

FIG. 2 is a rear view of one embodiment of the invention

FIG. 3 is an exploded view of one embodiment of present invention.

FIG. 4a is a view of one embodiment of a remote control as part of one embodiment of the invention

FIG. 4b is a view of another embodiment of a remote control as part of one embodiment of the invention

### DETAILED DESCRIPTION OF THE INVENTION

While the present invention is capable of embodiment in various forms, hereinafter is described an embodiment with the understanding that the present disclosure is to be considered as an exemplification of the invention, and is not intended to limit the invention to the specific embodiment illustrated.

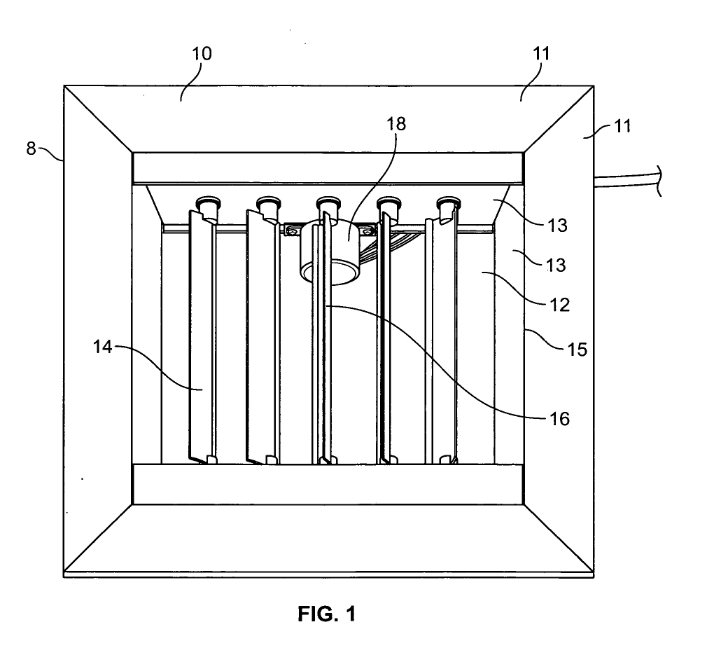

A front view of one embodiment of the invention is depicted in FIG. 1. Vent unit 8 has a frame 10, which has an opening 12. Frame 10 may be constructed of, for example, plastics, steel, stainless steel, iron, aluminum, titanium, tin, alloys thereof or other metal alloys, wood, or other composite materials. In a presently preferred embodiment the frame is constructed of aluminum. It will be appreciated by one of skill in the art that other materials will also be suitable for use in the frame; such other materials are within the ambit of the present invention. Frame 10 may be square, rectangular, circular, or any other shape commonly used as openings from HVAC ducts. Frame 10 should be of sufficient size to be installable in such a duct opening.

When frame 10 is of rectangular, square, or other quadrilateral shape, frame 10 is preferably constructed of four or more members 11 connected together. Members 11 have an inside edge 15 and an outside edge. The dimensions of the inside edges 15 of each of the members 11 are sized such that it comports with the dimensions of the duct terminus (not shown) and my be inserted therein. Such members 11 may be welded together, fastened by screws or other fasteners, or held together in any other suitable way as known in the art. The inner portion, or sidewalls 13, of frame 10 fits within a duct opening, while the outer portion of frame 10, constructed of members 11, preferably sits exterior to the duct opening and abutting the wall, floor, or ceiling where the duct opening is located. The dimensions of the outer portion of each of the members 11 is sized such that they extend outwardly and laterally from the duct terminus forming a flange that prevents the vent unit 8 from being inserted too far into the duct terminus. The outer portion may be fastened to the wall, floor, or ceiling to secure frame 10 in its location. Of course, other embodiments may be utilized that do not require the formation of a flange such as friction fit or coupling members.

Louvers 14 are pivotally connected to frame 10 and span opening 12. The number of louvers 14 may be determined by the size of frame 10, such that in a ‘closed’ position, louvers 14 prevent escape of all or approximately all forced air from the HVAC unit. Louvers 14 will typically be constructed of the same material as frame 10 for simplicity in materials; however, this is not necessary to the function of the invention as the invention will function with other suitable materials such as those listed above as suitable for frame 10. Louvers 14 may have a curvature or may be flat. Louvers 14 may be connected in any way that allows pivotal movement. Preferably, louvers 14 are connected on end to an interior drive mechanism, explained in further detail below.

In some embodiments there is also a center louver 16 that is stationary and does not pivot attached to frame 10. In other embodiments all louvers 14 pivot. In a further embodiment, center louver 16 is replaced with a solid member that does not pivot and is connected to frame 10. In another embodiment said member may be a chamber capable of housing, for example, batteries that may be used to power the device.

Drive unit 18 is visible through opening 12 behind louvers 14 or center louver 16. Drive unit 18 is used to engage pivoting louvers 14, and may be a motor, a “servo,” or any other such small drive unit as is known in the art. Drive unit 18 is preferably connected to frame 10, more preferably connected to the inner portion or sidewall 13 of frame 10. Located near drive unit 18 is a circuit board (not shown). The circuit board is connected to a remote sensor (not shown) and acts as the processing unit between the remote sensor and drive unit 18. The remote sensor receives signals from a remote control device. Such a device is discussed in further detail below. The circuit board processes the signals received by the remote sensor and translates the signals to activate drive unit 18 as directed by the remote control. The circuit board may be placed behind center louver 16, or may be placed in another appropriate place on the unit. In a preferred embodiment, the circuit board and remote sensor are located in a position behind the louvers. The placement of drive unit 18 as shown in FIG. 1, as well as placement of the circuit board and the remote sensor, is not limited to any one location, as one skilled in the art would easily be able to construct embodiments of the invention with the placement of drive unit 18, the circuit board and the remote sensor in other locations.

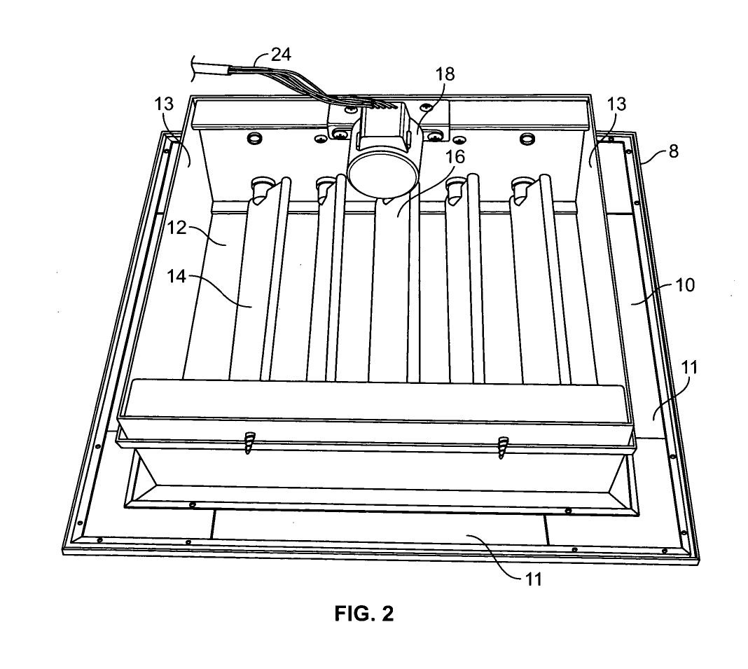

FIG. 2 depicts a rear view of one embodiment of the invention. The same elements discussed above are similarly visible in FIG. 2. Power cord 24 is shown and supplies power to drive unit 18 and the circuit board, and may be connected to drive unit 18, the circuit board, or both, in order to supply the necessary power. Power cord 24 is connected to a power supply (not pictured), which may be a battery or battery pack, a power outlet as are common in the home or other buildings, or hard wired into the electrical system of the building. In embodiments where center louver 16 is a member comprising a chamber, power cord 24 may be connected to batteries contained within the chamber. Other power supplies may be suitable as well.

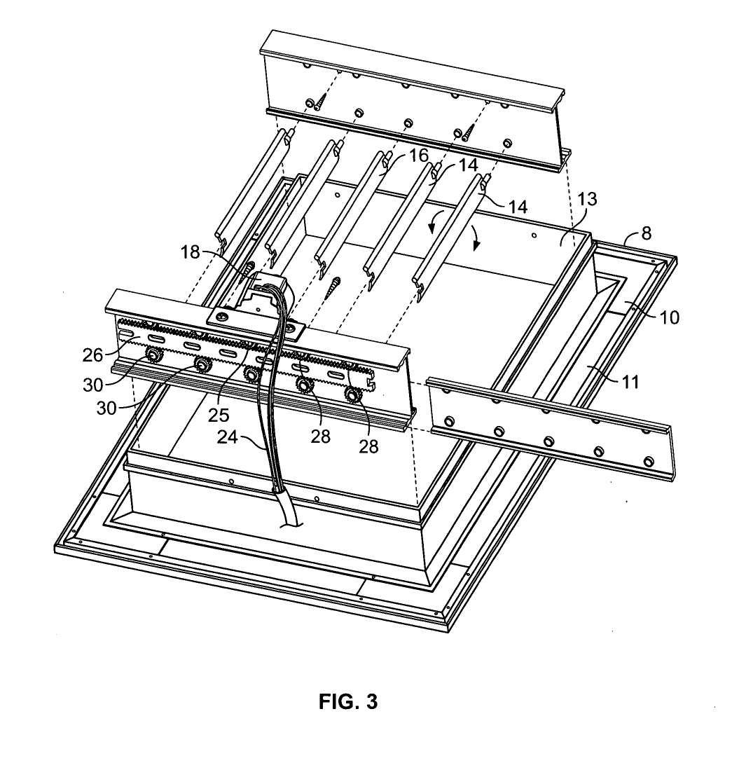

FIG. 3 is a view of one embodiment of present invention with an exploded view of the mechanism by which louvers 14 are pivoted. In the exploded view, movable member 26 is visible. Movable member 26 is connected to drive unit 18, such that drive unit 18 supplies the energy to cause movable member 26 to move. In this preferred embodiment drive unit 18 is a servo that includes a rotating gear 25. When drive unit 18 is actuated, rotating gear 25 rotates in either a clockwise or counterclockwise direction. The teeth from rotating gear 25 are engaged to teeth on movable member 26. Movable member 26 is fixed in the vertical position by pins (not shown) extending from sidewall 13 into a series of horizontally extending slots formed in movable member 26. Thus movable member 25 is free to move in either a forward or backward lateral direction.

Each louver 14 that is designed to pivot has a driven portion 28 connected to preferably one end. The driven portion 28 in the preferred embodiment is in the form of a gear rigidly connected to a cylindrical connector affixed to one end of the louvers 14. The driven portions 28 are engaged by the laterally spaced gear teeth on the edge of movable member 26. Each driven portion 28 is engaged by movable member 26, such that when drive unit 18 causes movable member 26 to move, the driven portions 28 are rotated causing the louvers 14 to pivot. The mechanism may optionally have guide members 30 that may be used to keep movable member 26 engaged with the driven portions 28. In a presently preferred embodiment, driven portions 28 are gears or portions of gears, and movable member 26 that moves laterally and has teeth that are designed to engage the gears. In such an embodiment, guide members 30 are also gears, preferably two such gears with one near each end of the movable member, but optionally more than two gears. In another embodiment, driven portions 28 could be bars connected to the tops of louvers 14 and attached to movable member 26, such that the movement of movable member 26 moves the bars which causes louvers 14 to pivot. Other configurations may also be utilized to translate the mechanical movement of drive unit 18 into rotational movement of the louvers 14, provided the louvers 14 are permitted to pivot at least 180 degrees. There may however be situations due to the location of the vent that make it undesirable to have 180 degree rotational movement. In such cases, the present invention may have limited rotational capacity.

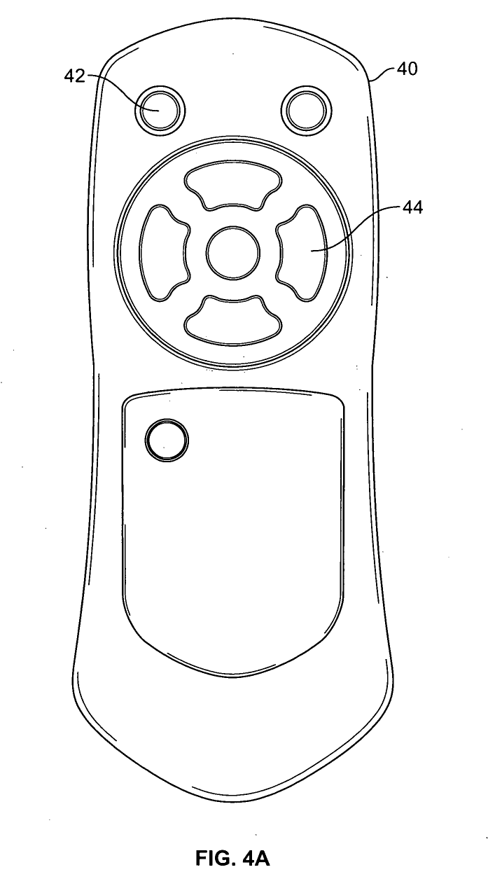

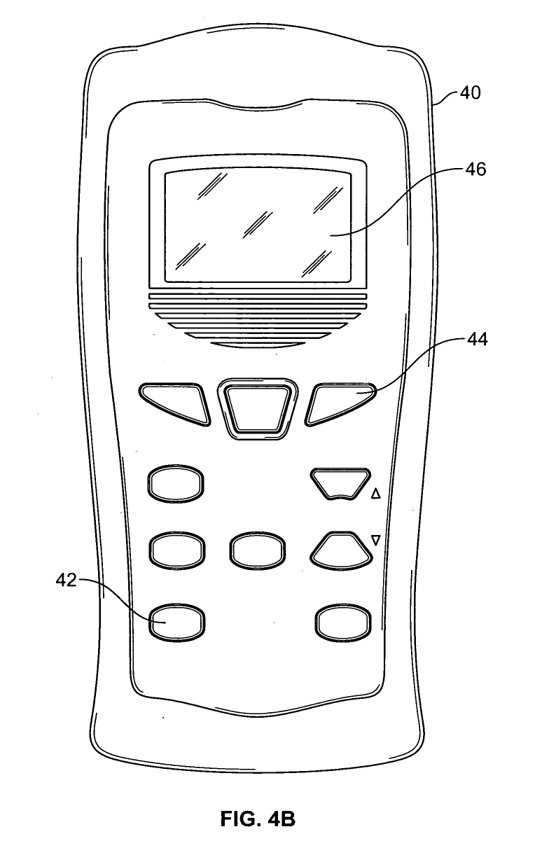

Drive unit 18 is controlled by remote control 40 via the remote sensor. FIGS. 4a and 4b show two possible embodiments of remote control 40. FIG. 4a shows a relatively simple version of remote control 40. In this embodiment, remote control 40 is equipped with buttons 42 to switch between multiple communication frequencies. The circuit board and remote sensor are preset to communicate a particular frequency, or may also have a frequency selection device. The frequencies available for selection on remote control 40 correspond with the frequencies utilized by the remote sensor of more than one unit 8. In this manner, a single remote control 40 may be used to control multiple units 8, making it simpler for an operator as only one remote control 40 will be needed to control all vent units 8 installed in a building.

In one embodiment, remote control 40 has buttons 44 to control the angle of louvers 14. In one such embodiment, the buttons 44 correspond to preset angles, as programmed by the manufacturer. In another embodiment, buttons 44 allow for pivoting of louvers 14 to any desired angle.

FIG. 4b shows another embodiment of remote control 40. In this embodiment, remote control 40 has buttons 42 for selection of communication frequency and buttons 44 that allow for control of the angles of louvers 14. Remote control 40 also has a screen 46. Screen 46 may be, for example, an LCD screen, and will show information such as the time and the temperature. The remote control 40 is equipped with a temperature sensor (not shown) that allows the temperature to be detected for display on screen 46. Using the buttons 44 and screen 46, an operator may program remote control 40 to cause louvers 14 to open (i.e. 90 degree angle), close (0 degree angle) or to go to any particular angle at a selected time. The operator may also select a temperature. Remote control 40 will then communicate with vent 8 to cause louvers 14 to open or close in order to maintain the selected temperature. The temperature and time selections may be used together as well to change temperature in a room at a selected time.

One of skill in the art will appreciate that other input devices besides buttons may be used in the present invention and still be within the ambit of the invention. For example, a knob could be used to select communication frequencies, or a knob could be used for control of the louver angle, whether preset by the manufacturer or unlimited control. Likewise, switches may be used to select communication frequencies or to control the louver angle.

In operation, a person may enter a room and place remote control 40 at his or her location. The person may then program remote control 40 to, for example, a desired temperature. The person may then keep remote control 40 in close proximity to his or her position in the room, or may place it at any desired location in the room. Remote control 40 senses the temperature via the temperature sensor. If the temperature sensed does not match the temperature programmed within an acceptable range, the remote control communicates with vent unit 8 via the remote sensor. This causes drive unit 18 to operate by driving movable member 26 enough such that driven portions 28 rotate and correspondingly the louvers 14 rotate to pivot to an open position, preferably the 90 degree position (full open), though other positions may be programmed. The louvers remain open until the temperature sensor of remote control 40 detects that the temperature has reached the programmed temperature. The remote control 40 communicates similarly as before with the vent unit 8, instead resulting in the louvers being pivoted to the 0 or 180 degree position (full closed).

In another embodiment, the person operating remote control 40 may utilize said remote control 40 to pivot louvers 14 without programming a temperature or a time. The operator may depress one of buttons 44 to select a pre-set louver 14 angle, or in another embodiment may depress one of buttons 44 to pivot louvers 14 until they reach a desired angle. Remote control 40 communicates as discussed above, and louvers 14 are pivoted as discussed above.

Although the invention has been described with respect to specific embodiments and examples, it should be appreciated that other embodiments utilizing the concept of the present invention are possible without departing from the scope of the invention. The present invention is defined by the claimed elements, and any and all modifications, variations, or equivalents that fall within the true spirit and scope of the underlying principles. All patent and literature references are hereby incorporated by reference as if fully set forth herein.

What is claimed is:

1. A remote control vent system, comprising:
a vent unit, comprising:
a) a frame having an opening;
b) a plurality of louvers pivotally connected to the frame;
c) a drive unit engaging the louvers
d) a remote control sensor in communication with the drive unit; and
a remote control unit that communicates with the remote control sensor.

2. The system of claim 1, wherein the vent unit further comprises a driven portion connected to each louver.

3. The system of claim 2, wherein the driven portion is a gear portion.

4. The system of claim 2, wherein the vent unit further comprises a toothed member movable by the drive unit and engaging each driven portion.

5. The system of claim 1, wherein the remote control unit further comprises at least one input device engageable by an operator.

6. The system of claim 5, wherein the louvers may be pivoted to achieve a plurality of angled positions relative to the frame and the at least one input device is utilized by an operator to change the angle of the plurality of louvers.

7. The system of claim 1, wherein the remote control unit further comprises a temperature sensor.

8. The system of claim 7, wherein the remote control is programmable by an operator to a selected temperature.

9. The system of claim 1, wherein the remote control is programmable by an operator to specify one or more selected times.

10. The system of claim 8, wherein the remote control is programmable by an operator for a selected time, whereby the selected temperature is activated at the selected time.

11. The system of claim 1, wherein the remote control unit further comprises a display screen.

12. The system of claim 1, wherein the remote control further comprises an input device to change the communication frequency of the remote control.

13. The system of claim 12, wherein the vent further comprises an input device to change the communication frequency of the vent.

14. The system of claim 1, wherein the remote control is programmable to specific louver angles.

15. The system of claim 14, wherein the louver angles are preset.

16. A method for controlling the temperature of a selected location in a room, said method comprising the steps of:
a) installing a vent unit having a drive unit and remote control sensor in the room, wherein the vent unit conveys air from a heating or cooling source;
b) providing a remote control that communicates with the drive unit via the remote control sensor, the remote control being programmable by an operator to a selected temperature and having a temperature sensing device;
c) programming the remote control to a selected temperature;
d) placing the remote control at the selected location.

17. The method of claim 16, wherein the remote control provided is also programmable by an operator to specify a selected time.

18. The method of claim 17, wherein the method further comprises programming the remote control to a selected time.

19. The method of claim 16, wherein the selected location is associated with a location of an individual which is subject to change as the individual moves within the room.

20. A remote control vent unit adapted to be connected to a duct opening, comprising:
a) a frame having an opening;
b) a plurality of louvers pivotally connected to the frame;
c) a drive unit;
d) a driven portion connected to each respective louver;
e) a remote control sensor in communication with the drive unit
f) a movable member connected to the drive unit and engaging the driven portions.

21. The vent unit of claim 20, wherein the unit is operable by use of a remote control.

22. A remote control vent system comprising:
a vent unit, comprising:
a) a frame having an opening;
b) a plurality of louvers pivotally connected to and in communication with the opening in the frame;
c) at least one gear portion connected to each louver;
d) a drive unit;
e) a remote control sensor in communication with the drive unit;
f) a toothed member movable by the drive unit and engaging the gear portions; and
a remote control unit, wherein said remote control unit communicates with the remote control sensor to control the drive unit, comprising:
a) at least one input device engageable by an operator;
b) a temperature sensor;
c) a display screen;
wherein the remote control unit is programmable by an operator to a selected temperature at a selected location of the remote control unit.

23. The system of claim 22, wherein the remote control is programmable by an operator for a selected temperature at a selected location of the remote control at a selected time.
